(19) United States
(12) Patent Application Publication
(10) Pub. No.: US 2003/0062871 A1
(43) Pub. Date: Apr. 3, 2003

(54) Circuit and method for controlling an electric motor

(76) Inventors: Alexei Antonov, Toronto (CA); Dmitri Talanov, Toronto (CA)

Correspondence Address: Alexei Antonov, 22 Close Ave. #1413, Toronto, ON, M6K 2V4, CA

(21) Appl. No.: 09/969,351

(22) Filed: Oct. 3, 2001

(51) Int. Cl. H02P 1/24; H02P 1/42; H02P 3/18; H02P 5/28; H02P 7/36

(52) U.S. Cl. 318/727

(57) ABSTRACT

A circuit and a method for controlling an electric motor are provided. The circuit and the method are suitable for a conventional three-phase AC motor having three phase terminals and a power source having two terminals. The power source may have a stable DC voltage level, such as a battery, or a floating DC voltage level, such as a rectified AC power source. The invention brings performance of a conventional three-phase AC motor close to performance of a conventional DC motor, with an added advantage of independent torque and speed controls. The circuit and the method are suitable for other types of electric motors, such as brushless DC motor.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to circuits and methods for controlling polyphase electric motor, and more particularly, to methods and circuits for conventional AC motor or for brushless DC motor. This invention further relates to methods and circuits for conventional AC motor or for brushless DC motor with torque and speed controls.

A conventional three-phase AC motor includes a stator having a plurality of windings and a rotor having a conductor in either form of squirrel cage or wound rotor. The rotor is made of magnetic material such as iron. The rotor of a squirrel cage further has conductive bars that are parallel to the shaft and short circuited by shroud rings in which they are physically supported at each end. Bar size, shape and resistance significantly influence torque-speed characteristics of a motor with that type of rotor.

The wound rotor AC motor operates on the same principles as the squirrel cage motor but differs in the construction of the rotor. Instead of shorted bars, the rotor has windings, which terminate at slip rings on the shaft. Connection of external resistance to the rotor circuit, via the slip rings, permits variation of motor torque-speed characteristics. However, this is at the expense of electrical efficiency and additional servicing maintenance.

There are control methods and circuits for a conventional AC motor, which provide variable speed and torque control. That is typically achieved by emulating three-phase power source and controlling its voltage and frequency. The methods employ pulse-width modulation, often incorporate microprocessors and require fast switches. However, the use of such complex circuitry is disadvantageous, because it increases the cost of the system and limits the bandwidth of electrical signals within the control system for the motor.

Thus, there is a need for a circuit and a method for controlling an electric motor, such as a conventional AC motor, that will minimize or eliminate one or more of the above-mentioned deficiencies.

### BRIEF SUMMARY OF THE INVENTION

The circuit of this invention connects electric motor having a rotor and plurality of terminals and a power source having two terminals. The power source may have a stable DC voltage level, such as a battery, or a floating DC voltage level, such as a rectified AC power source. The circuit includes first set of switches connecting first power terminal to motor terminals, second set of switches connecting second power terminal to motor terminals, and a current sensor sensing current flowing through the motor. The circuit further includes control circuit controlling said switches responsive to said current sensor, Torque Control Input and Speed Control Input.

The method of this invention includes two steps: Commutation State and Wait State.

Commutation State is a condition when at least one switch from the first set is closed and at least one switch from the second set is closed with direct current flowing through the motor. There is a number of different Commutation States for a motor. Commutation States for a motor form a sequence. Next Commutation State associates with the next position of the rotor. Change of Commutation State causes rotor to turn into that new position. When the motor is in Commutation State, the current through the motor tends to grow unless it reaches its maximum or saturation level. In according to this invention, when the current becomes bigger than predetermined level, Commutation State ends and Wait State begins. Said predetermined level can be used to control torque of the motor. Higher predetermined level corresponds to higher torque of the motor. Means to set said predetermined level is mentioned above as Torque Control Input. Said predetermined level can also be used to allow operation of the motor from DC source with floating voltage level. For normal operation predetermined level should be less than saturation current. Making predetermined level to change with the change of the voltage level allows for normal operation from DC source with floating voltage level.

Wait State is a condition when all switches from the first set are opened or when all switches from the second set are opened. Wait State ends and next Commutation State begins when the current, as measured by the current sensor, becomes less than said predetermined level and a time interval or intervals expired. Means to set said time interval or intervals is mentioned above as Speed Control Input. Said time intervals measured from the beginning of the Wait State or from the end of the previous Wait State. Interval measured from the beginning of Wait State corresponds to upper speed limit of the motor. Interval measured from the end of Wait State corresponds to lower speed limit of the motor.

This invention allows switch-mode control for a conventional AC motor. A circuit and method in accordance with the present invention achieve conventional control goals. The inventive circuit and method do not require controlling voltage and frequency of the emulated three-phase power source, yet it has the ability to control motor torque and speed independently.

The control circuitry is less expensive than conventional motor controls. Moreover, the electrical signals within the control system for the motor can operate within a greater bandwidth than is possible with conventional control circuits.

### BRIEF DESCRIPTION OF THE SEVERAL VIEWS OF THE DRAWING

FIG. 1 is a block diagram illustrating a circuit in accordance with the present invention.

### DETAILED DESCRIPTION OF THE INVENTION

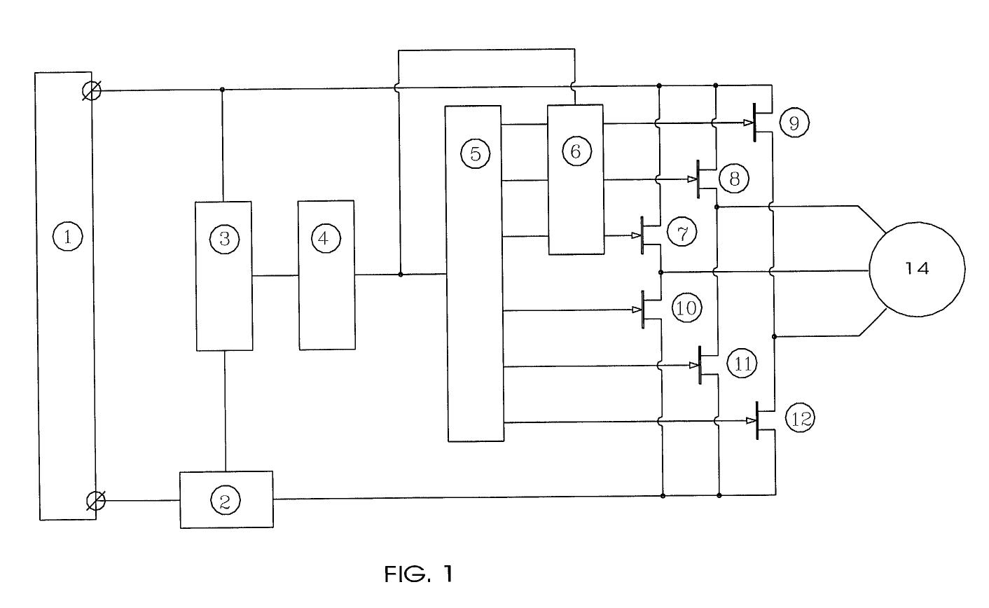

Referring now to FIG. 1, a motor 14 with three contact terminals and, more particularly conventional three-phase AC motor or brushless three-phase DC motor is being controlled. Although the illustrated embodiment includes three motor terminals, it will be understood by those skilled in the art that the number of motor terminals may vary.

Switches 7, 8, 9 connect motor 14 to power supply 1 positive polarity terminal. The switches could be of one or more stages and utilize MOS transistors, bipolar transistors or any other circuit making and braking means as known in the art. We use PNP transistors in Darlington configuration.

Switches 10, 11, 12 connect motor 14 to power supply 1 negative polarity terminal. The switches could be of one or more stages and utilize MOS transistors, bipolar transistors or any other circuit making and braking means as known in the art. We use NPN transistors in Darlington configuration.

Disable Circuit 6 drives switches 7, 8, 9 and allows disconnecting motor 14 from power supply 1 positive terminal. The circuit can be made on negative terminal. The function of the circuit is logical AND of signal from Speed Control Circuit 4, with signals from State Machine 5.

State Machine 5 drives switches 10, 11, 12 directly and switches 7, 8, 9 through Disable Circuit 6. State Machine 5 changes outputs at a rising edge of signal from Speed Control Circuit 4. Periodical row of states is motor specific as well as number of outputs. For this particular three-phase motors we use the control sequence for brushless three-phase DC motor well known in the art. The sequence could best be explained as:

At each state one motor terminal is connected to positive power terminal, another motor terminal is connected to negative power terminal, remaining motor terminal is not connected. At the next state one of connected motor terminals becomes disconnected and disconnected motor terminal becomes connected in its place. The choice of motor terminal to become disconnected defines the direction of the rotation of the motor. To keep the direction, one should choose the one not affected by previous change.

We use six bit shift register shifting head into tail with two neighboring bits set at power-on. In a general case of N-terminal motor we recommend a free-running counter with a decoder. State machine design is a common knowledge in the art.

Current Sensor 2 provides current indicative signal to Torque Control Circuit 3. We use a resistor as current sensor.

Torque Control Circuit 3 compares current indicative signal from Current Sensor 2 with the reference value. By changing said reference value the torque of the motor can be controlled. Reference value can be in analog form and be compared to current signal, or it can be in digital form and digital-analog converter can be used, or analog-digital converter may bring the current signal to digital form for comparison. The output of the circuit is a one-bit digital signal, which is at HIGH logic level when current signal is above reference level and at LOW logic level otherwise.

We use a comparator to make comparison in analog form and use a resistor divider for reference level. This makes the reference level to track power supply voltage and allow change of the level by varied value of the resistors in the divider.

Speed Control Circuit 4 modifies signal from Torque Control Circuit 3 and provides signal for Disable Circuit 6 and for State Machine 5. The outgoing signal is inverted comparing to incoming signal, and LOW to HIGH transition of outgoing signal is delayed comparing to the transition from HIGH to LOW of incoming signal. As an implementation of the delay we use Monostable Multivibrator, which allows us to change the delay and therefore to control the speed of the motor. As it is known in the art, there are numerous ways to implement various delay controls including RC circuits, counters, timers, microprocessors or combinations of those.

DC Power Supply 1 may have a stable DC voltage level, such as a battery, or a floating DC voltage level, such as a rectified AC power source.

We have described the implementation of the invention in its simplest and most clear form using simplest, off the shelve components. It should be clear to those skilled in the art, that all or some parts of the circuit can be integrated, still remaining within the scope of this invention.

We claim:

1. A method for controlling an electric motor having plurality of terminals from DC power source having two terminals, comprising the steps of:
a) connecting at least one motor terminal to first power source terminal and connecting at least one another motor terminal to second power source terminal;
b) determining that the current through the motor exceeds predetermined level;
c) disconnecting at least one power source terminal from all motor terminals;
d) determining that the current through the motor becomes lower than said predetermined level.

2. The method of claim 1, where said predetermined level can be altered.

3. The method of claim 1, where said predetermined level depends on the voltage of said power source.

4. The method of claim 1, where step ‘a’ includes starting a time interval and step ‘d’ includes determining that said time interval has expired.

5. The method of claim 4, where said time interval can be altered.

6. The method of claim 1, where step ‘c’ includes starting a time interval and step d) includes determining that said time interval has expired.

7. The method of claim 6, where said time interval can be altered.

8. A circuit for controlling an electric motor having plurality of terminals from DC power source having two terminals, comprising of:
switches connecting every motor terminal to first power source terminal;
switches connecting every motor terminal to second power source terminal;
a current sensor sensing current flowing through said motor;
a drive circuit responsive to said current sensor driving said switches.

9. The circuit of claim 8, where said drive circuit powered from said power source.

10. The circuit of claim 8, where said drive circuit responsive to torque control input.

11. The circuit of claim 8, where said drive circuit responsive to speed control input.
